(19) United States
(12) Patent Application Publication
(10) Pub. No.: US 2026/0139637 A1
(43) Pub. Date: May 21, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventors: Masanao IDOGAWA, Nagoya-shi (JP); Yasuaki MURAKAMI, Toyota-shi (JP)

(73) Assignee: TOYOTA JIDOSHA KABUSHIKI KAISHA, Toyota-sh (JP)

(21) Appl. No.: 19/334,160

(22) Filed: Sep. 19, 2025

(30) Foreign Application Priority Data
Nov. 19, 2024 (JP) 2024-201644

(51) Int. Cl. F02D 41/14; F02D 1/02

(52) U.S. Cl. CPC F02D 41/1401; F02D 1/02; F02D 2041/1412

(57) ABSTRACT

A control device, for an internal combustion engine, includes an injection control unit configured to control a first fuel injection valve provided in a cylinder of the internal combustion engine, a prediction unit configured to predict a load factor of the internal combustion engine, and a setting unit configured to determine a required amount of fuel injection amount based on the predicted load factor. The injection control unit is configured to perform fuel injection of a first amount smaller than the required amount from the first fuel injection valve, when the predicted load factor is larger than an actual load factor.

### CROSS-REFERENCE TO RELATED APPLICATION

This application is based upon and claims the benefit of priority of the prior Japanese Patent Application No. 2024-201644, filed on Nov. 19, 2024, the entire contents of which are incorporated herein by reference.

### TECHNICAL FIELD

The present disclosure relates to a control device for an internal combustion engine.

### BACKGROUND

Fuel is injected from a fuel injection valve to an internal combustion engine. A technique is known in which an intake air amount is predicted at the end of an intake stroke, and additional fuel injection is performed based on the prediction (Japanese Unexamined Patent Application Publication No. 2005-069045).

The fuel injection amount may be determined in accordance with the prediction of a load factor. However, the prediction accuracy of the load factor is low, and the predicted value of the load factor may be different from an actual load factor. A required injection amount of fuel determined based on the predicted load factor might deviate from a fuel injection amount corresponding to an actual load factor. When the fuel is excessive, it is difficult to adjust the fuel injection amount.

### SUMMARY

It is therefore an object of the present disclosure to provide a control device, for an internal combustion engine, capable of adjusting a fuel injection amount.

The above object is achieved by a control device, for an internal combustion engine, including: an injection control unit configured to control a first fuel injection valve provided in a cylinder of the internal combustion engine; a prediction unit configured to predict a load factor of the internal combustion engine; and a setting unit configured to determine a required amount of fuel injection amount based on the predicted load factor, wherein the injection control unit is configured to perform fuel injection of a first amount smaller than the required amount from the first fuel injection valve, when the predicted load factor is larger than an actual load factor.

The injection control unit may be configured to perform fuel injection of the required amount from the first fuel injection valve, when the predicted load factor is equal to or smaller than the actual load factor.

The injection control unit may be configured to perform additional fuel injection in addition to the fuel injection of the first amount, when the first amount is smaller than a fuel injection amount corresponding to the actual load factor.

A second fuel injection valve may be provided in an intake passage of the internal combustion engine, the injection control unit may be configured to control the first fuel injection valve and the second fuel injection valve, and the injection control unit may be configured to perform the additional fuel injection from the first fuel injection valve or the second fuel injection valve.

The injection control unit may be configured to set the fuel injection amount to the first amount by preferentially reducing an injection amount of a fuel injection on an advance side rather than a fuel injection on a retard side in multi-injection performed by the first fuel injection valve.

### BRIEF DESCRIPTION OF THE DRAWINGS

FIG. 1 is a schematic view illustrating an internal combustion engine;

FIG. 2 is a flowchart illustrating a process in the embodiment;

FIG. 3 is a view illustrating a time chart;

FIG. 4 is a view exemplifying a time chart; and

FIG. 5 is a schematic view illustrating an injection timing.

### DETAILED DESCRIPTION

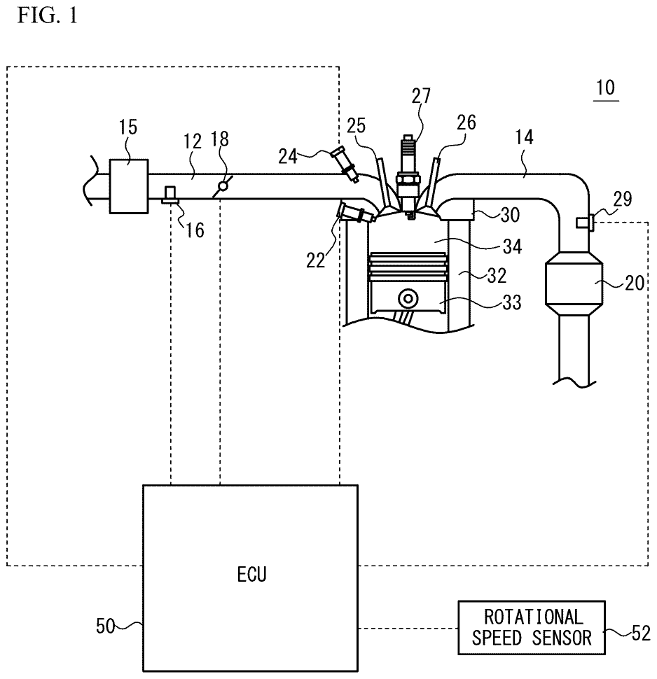

Hereinafter, a control device for an internal combustion engine of the present embodiment will be described with reference to the drawings. FIG. 1 is a schematic view illustrating an internal combustion engine 10, and illustrates one cylinder. The internal combustion engine 10 burns fuel and outputs power. The fuel is, for example, gasoline, alcohol, hydrogen fuel, or the like.

The internal combustion engine 10 has a cylinder head 30 and a cylinder block 32. The cylinder head 30 is mounted on the cylinder block 32. A piston 33 is accommodated in the cylinder block 32. In each cylinder, a combustion chamber 34 is defined by the piston 33, the cylinder block 32, and the cylinder head 30.

The cylinder head 30 is provided with a fuel injection valve 22 (first fuel injection valve), an intake valve 25, an exhaust valve 26, and a spark plug 27. The fuel injection valve 22 is a direct injection injector and injects fuel directly into the cylinder. An intake pipe 12 and an exhaust pipe 14 are connected to the cylinder head 30.

An air cleaner 15, an air flow meter 16, a throttle valve 18, and a fuel injection valve 24 (second fuel injection valve) are provided in the intake pipe 12 in this order from the upstream side. The fuel injection valve 24 is an injector for port injection, and injects fuel into the intake pipe 12.

The air cleaner 15 removes dust and the like from the air. The air flow meter 16 detects the flow rate of air. The throttle valve 18 adjusts the flow rate of air. The flow rate of the air increases as the opening degree of the throttle valve 18 increases. The smaller the opening, the smaller the flow rate.

When the intake valve 25 is opened, air flows into the combustion chamber 34 from the intake pipe 12. The fuel injected from the fuel injection valve 22 or 24 is also introduced into the combustion chamber 34. The air and the fuel form a mixture. The spark plug 27 ignites the air-fuel mixture. The combustion of the air-fuel mixture generates a driving force.

Exhaust gas generated by the combustion is discharged to the exhaust pipe 14 when the exhaust valve 26 is opened. A catalyst 20 provided in the exhaust pipe 14 purifies PM, carbon monoxide (CO), unburned fuel (HC), nitrogen oxides (NOx), and the like in the exhaust gas. An air-fuel ratio sensor 29 is provided in the exhaust pipe 14 at a location upstream of the catalyst 20. The air-fuel ratio sensor 29 detects the air-fuel ratio. A rotational speed sensor 52 detects the rotational speed of the internal combustion engine 10 (engine speed).

An electronic control unit (ECU) 50 is a control device for the internal combustion engine 10, and includes a calculation device such as a central processing unit (CPU), and storage devices such as a read only memory (ROM) and a random access memory (RAM).

The ECU 50 controls the valve timings of the intake valve 25 and the exhaust valve 26. The ECU 50 acquires the flow rate of the air detected by the air flow meter 16. The ECU 50 acquires the air fuel ratio detected by the air-fuel ratio sensor 29. The ECU 50 acquires the rotational speed detected by the rotational speed sensor 52.

The ECU 50 controls the fuel injection valves 22 and 24, and controls the injection timings, the number of injections, and the injection amount. The ECU 50 performs both direct injection using the fuel injection valve 22 and port injection using the fuel injection valve 24, or performs only one of these.

A needle is provided in a housing of the fuel injection valve. The ECU 50 energizes the fuel injection valve to control the lift amount of the needle. When the lift amount of the needle is zero, the fuel injection valve is closed. The lift of the needle opens the fuel injection valve. When the lift amount is the maximum (100%), the fuel injection valve is fully opened. The fuel injection performed at the full opening is referred to as a full lift injection. Injection performed in a state where the lift amount is larger than zero and smaller than the maximum lift amount is referred to as partial lift injection. A lower limit (minimum injection amount) of the injection amount from the fuel injection valve is determined according to the lift amount of the needle, the pressure of the fuel (fuel pressure), and the like.

The injection of the required fuel injection amount at one time in one injection cycle is referred to as single injection. The injection of the required fuel injection amount in a divided manner in one injection cycle is referred to as multi-injection.

The ECU 50 controls the opening degree of the throttle valve 18 (throttle opening degree). The load factor of the internal combustion engine 10 is acquired according to the opening. The load factor is a ratio of a volume of air sucked from the intake pipe 12 in one cycle to a volume of the internal combustion engine 10 per cycle. The ECU 50 functions as a prediction unit that predicts the load factor in accordance with the throttle opening degree and the like. The ECU 50 functions as an injection control unit that controls the fuel injection valves 22 and 24, and a setting unit that sets a required amount of fuel injection based on a predicted load factor.

The ECU 50 controls the opening degree of the throttle valve 18 (throttle opening degree) and predicts the load factor and the injection amount so that, for example, the air fuel ratio falls within a predetermined range. However, when the torque is changed, the prediction accuracy of the load factor and the injection amount is reduced.

The ECU 50 calculates a predicted value (target value) Os of the throttle opening degree by using, for example, the following Equation (1). Or is the throttle opening degree at the prediction time. Δ O is a rate of change of the throttle opening degree at the prediction time. At is a time from the prediction time to the valve closing timing (IVC) of the intake valve 25.

Os−Or+ΔO×Δt (1)

When the engine speed is low, the time Δt becomes long. For example, when the throttle opening degree changes due to acceleration or the like, the inclination AO increases. The predicted value Os of the throttle opening degree becomes large. The predicted value KLp of the load factor also becomes a large value like the throttle opening degree, and may become larger than the actual load factor KLr.

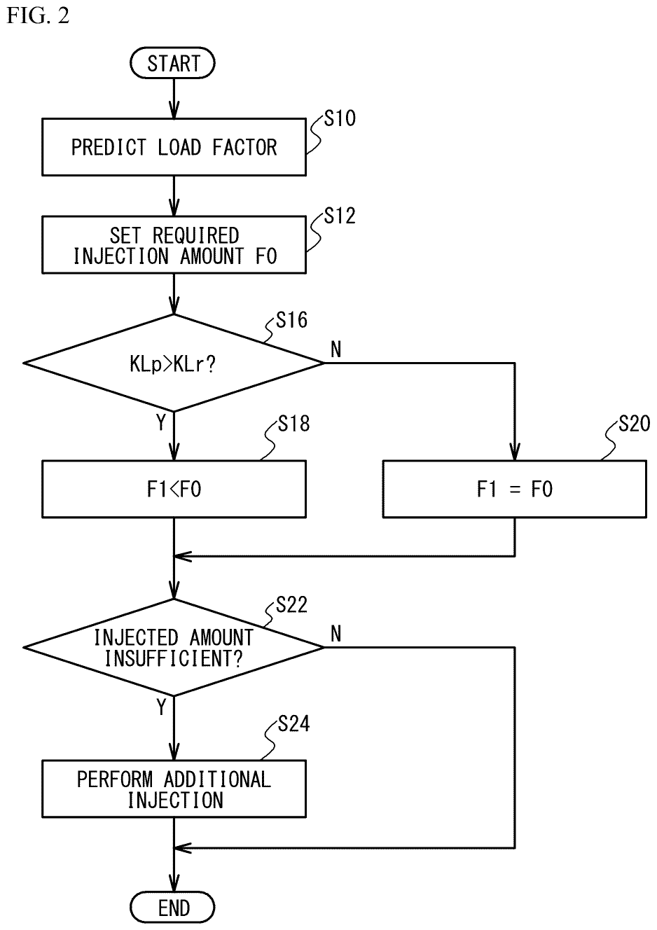

In general, the higher the load factor, the larger the fuel injection amount. The ECU 50 increases the fuel injection amount in accordance with the predicted load factor KLp. However, when the prediction accuracy is low, the fuel injection amount becomes excessively large or small with respect to the injection amount corresponding to the actual load factor. If the fuel injection amount is too small, additional injection may be performed. However, when an excessive amount of fuel is injected, the adjustment is difficult. In the embodiment, the fuel injection amount is controlled, and the fuel is adjusted. FIG. 2 is a flowchart illustrating processing in the embodiment. The prediction unit of the ECU 50 predicts a predicted value KLp of the load factor (step S10). The setting unit of the ECU 50 sets the required injection amount F0 based on the predicted load factor KLp of the internal combustion engine 10 (step S12). The prediction of the load factor KLp and the calculation of the injection amount F0 are continuously performed with the passage of time.

At the timing of determining the fuel injection amount, the ECU 50 determines whether the predicted value KLp is larger than the actual load factor KLr (step S16). In a case of a positive determination (Yes), the injection control unit sets the injection amount F1 (first amount) of the fuel to a value smaller than the required injection amount F0, and performs injection from the fuel injection valve 22 (step S18). The F1 at this time is smaller than the required injection amount F0, and is, for example, 90% of the F0. In a case of a negative determination (No), the injection control unit sets the injection amount F1 to F0 and performs injection from the fuel injection valve 22 (step S20).

The ECU 50 determines whether or not the injected fuel is insufficient with respect to the required amount, for example, at the valve-closing timing (IVC) of the intake valve 25 (step S22). In the case where the injected fuel is insufficient, the injection control unit performs additional injection from the fuel injection valve 22 or the fuel injection valve 24 (step S24). After step S24 or when the injected fuel is sufficient in step S22, the process of FIG. 2 ends.

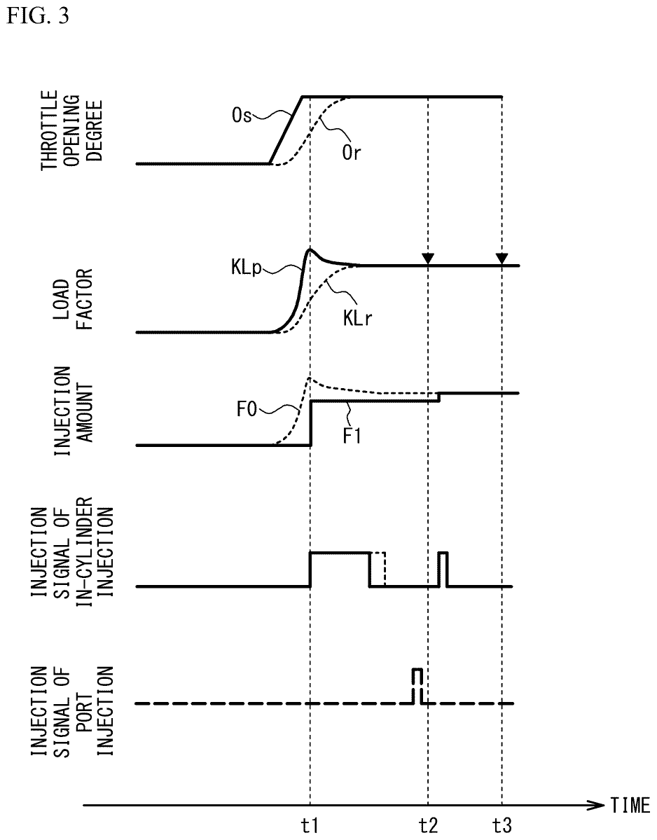

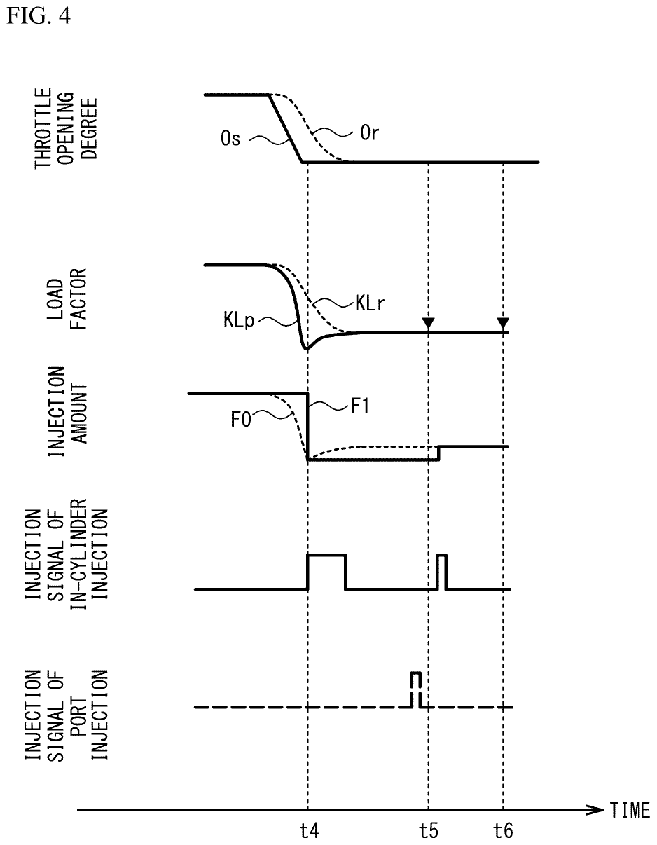

FIGS. 3 and 4 are views illustrating time charts. FIG. 3 illustrates an example in which the predicted load factor KLp is higher than the actual load factor KLr. FIG. 4 illustrates an example in which the predicted load factor KLp is equal to or less than the actual load factor KLr. In FIGS. 3 and 4, the opening degree of the throttle valve 18, the load factor, the fuel injection amount, the injection signal of the in-cylinder injection, and the injection signal of the port injection are illustrated in order from the top. The dotted lines represent the actual throttle opening degree Or, the actual load factor KLr, the required injection amount F0, and the injection signal corresponding to the required injection amount F0. The solid lines represent the target value Os of the throttle opening degree, the predicted load factor KLp, the injection amount F1, and the injection signal corresponding to the injection amount F1.

In the example of FIG. 3, the throttle opening degree increases, and the load factor KLr increases. For example, the throttle opening is estimated by the above equation (1), and the predicted load factor KLp is obtained based on the estimation. The predicted load factor KLp is larger than the actual load factor KLr in the vicinity of the time t1. The required injection amount F0 is determined in accordance with the predicted load factor KLp. The ECU 50 determines the injection amount of fuel, for example, at the time t1. The ECU 50 is set the injection amount F1 to a value smaller than the required injection amount F0, for example, to about 90% of F0 (step S18 in FIG. 2). The pulse width of the injection signal is shortened. The lift amount of the fuel injection valve 22 changes in accordance with the pulse width of the injection signal, and the injection amount is adjusted to F1. The time t2 is the valve-closing timing (IVC) of the intake valve 25. The predicted load factor KLp approaches the actual load factor KLr near the IVC. If the actual injection amount F1 is smaller than the required injection amount F0 in the IVC, additional injection is performed (step S24). At time t3, the spark plug 27 performs ignition.

In the example of FIG. 4, the throttle opening degree decreases, and the load factor KLr decreases. The predicted load factor KLp is equal to or less than the actual load factor KLr near the time t4. The ECU 50 determines the injection amount of fuel, for example, at the time t4. The ECU 50 makes the injection amount F1 equal to the required injection amount F0 (step S20 in FIG. 2). If the actual injection amount F1 does not reach the required injection amount at the IVC (time t5), additional injection is performed (step S24). At time t6, the spark plug 27 performs ignition.

For example, when the fuel injection valve 22 for in-cylinder injection cannot be used for preventing thermal damage, additional injection may be performed from the fuel injection valve 24 for port injection (broken lines in FIGS. 3 and 4). If the injection amount F1 is sufficient for the actual load factor KLr, additional injection may not be performed.

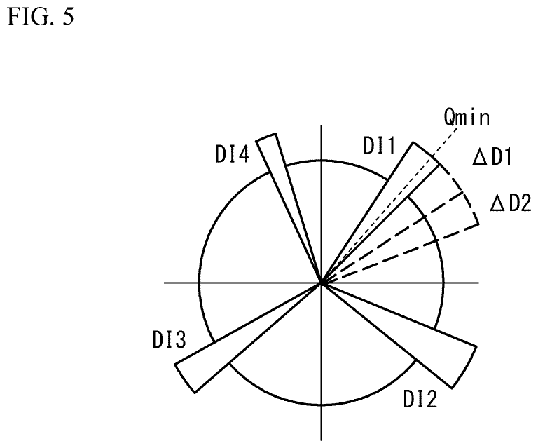

FIG. 5 is a schematic view illustrating the injection timing. The right half represents the intake stroke. The left half represents the compression stroke. The cycle proceeds clockwise. Four direct injections DI1, DI2, DI3, and DI4 are performed in order. The broken lines represent the amount of decrease from the required injection amount F0. ΔD1 and ΔD2 are reduced from DI1 (step S18 in FIG. 2). ΔD1 corresponds to, for example, 10% of DI1 before the reduction. Δ D2 corresponds to, for example, 10% of DI2.

Qmin is the lower limit of the injection amount (minimum injection amount) in single injection, and is determined by the lift amount of the needle of the fuel injection valve, the fuel pressure, and the like. The injection amount in single injection is equal to or greater than Qmin. In the example in FIG. 5, ΔD1 and ΔD2 are reduced from the injection amount of the first injection DI1. When the injection amount is further reduced from DI1, the injection amount becomes smaller than Qmin. Therefore, the ECU 50 reduces the injection amount of DI2, not the DI1. That is, even when the injection amount decreases, the injection amount does not become less than Qmin.

As in the example of FIG. 5, when the multiple injection is performed and the injection amount becomes smaller than the required injection amount F0 (step S18), the ECU 50 decreases preferentially the injection on the advance side rather than the injection on the retard side in the multiple injection. In the example of FIG. 5, the injection amount of DI1 decreases and is equal to or greater than the minimum injection amount Qmin. When the injection amount is further reduced, the injection amount of the DI2 is reduced. When the injection amount of DI2 approaches Qmin, the injection amount of DI3 is reduced.

The injection amount is not reduced for the injection DI4 in the latter half of the compression stroke. The injection amount of DI4 has a large influence on the air-fuel mixture. The generation of the air-fuel mixture is prioritized over the reduction of the fuel injection amount.

According to the embodiment, the ECU 50 predicts the predicted value KLp of the load factor and sets the required injection amount F0 based on the predicted value KLp. When the predicted load factor KLp is larger than the actual load factor KLr, the ECU 50 reduces the fuel injection amount F1 to be smaller than the required injection amount F0 (step S18 in FIG. 2). Since the F0 less than the required injection amount F1 is injected without injecting the excessive fuel, the fuel injection amount is adjusted.

If the predicted load factor KLp is equal to or less than the actual load factor KLr, the ECU 50 performs injection of the required injection amount F0 from the fuel injection valve 22 (step S20). The fuel injection amount is adjusted regardless of whether the predicted load factor KLp is larger or smaller than the actual load factor KLr.

When the fuel injection amount F1 is insufficient for the injection amount corresponding to the actual load factor KLr, additional injection may be performed (step S24). If the injection amount is sufficient in the F1, the additional injection is not performed. The fuel injection amount is adjusted.

For example, the additional injection is performed near the IVC. Since the additional injection is performed at a timing close to the ignition timing, the additional injection may affect the air-fuel mixture. When the injection amount F0 satisfies the required amount corresponding to the actual load factor KLr, the additional injection may not be performed. The influence on the generation of the air-fuel mixture is unlikely to occur.

As described above, if the predicted load factor KLp is smaller than the actual load factor KLr, the fuel injection amount F1 is less than the required injection amount F0. In this case, the fuel injection amount F1 may be, for example, 80% of the required injection amount F0 or more, 90% or more, or 95% or more, and is less than F0. Since excessive fuel is not injected, the fuel injection amount is adjusted.

The fuel injection valve 22 injects the injection amount F1. If the injection amount F1 is insufficient, the fuel injection valve 22 or the fuel injection valve 24 performs the additional injection (step S24). Because additional port injections are possible from the fuel injection valve 24, the fuel injection valve 22 may not be used in series. The thermal damage of the fuel injection valve 22 is suppressed. The additional injection by the fuel injection valve 24 is performed before the IVC. The fuel injected by port injection is introduced into the combustion chamber 34 through the intake port that is open.

As in the example of FIG. 5, the fuel amount is reduced by giving priority to the injection on the advance side over the injection on the retard side. The influence of the change in the fuel injection amount on the air-fuel mixture is small, and the combustion is unlikely to deteriorate.

Although some embodiments of the present disclosure have been described in detail, the present disclosure is not limited to the specific embodiments but may be varied or changed within the scope of the present disclosure as claimed.

What is claimed is:

1. A control device, for an internal combustion engine, comprising:
an injection control unit configured to control a first fuel injection valve provided in a cylinder of the internal combustion engine;
a prediction unit configured to predict a load factor of the internal combustion engine; and
a setting unit configured to determine a required amount of fuel injection amount based on the predicted load factor,
wherein the injection control unit is configured to perform fuel injection of a first amount smaller than the required amount from the first fuel injection valve, when the predicted load factor is larger than an actual load factor.

2. The control device, for the internal combustion engine, according to claim 1, wherein the injection control unit is configured to perform fuel injection of the required amount from the first fuel injection valve, when the predicted load factor is equal to or smaller than the actual load factor.

3. The control device, for the internal combustion engine, according to claim 1, wherein the injection control unit is configured to perform additional fuel injection in addition to the fuel injection of the first amount, when the first amount is smaller than a fuel injection amount corresponding to the actual load factor.

4. The control device, for the internal combustion engine, according to claim 3,
wherein
a second fuel injection valve is provided in an intake passage of the internal combustion engine,
the injection control unit is configured to control the first fuel injection valve and the second fuel injection valve, and
the injection control unit is configured to perform the additional fuel injection from the first fuel injection valve or the second fuel injection valve.

5. The control device, for the internal combustion engine, according to claim 1, wherein the injection control unit is configured to set the fuel injection amount to the first amount by preferentially reducing an injection amount of a fuel injection on an advance side rather than a fuel injection on a retard side in multi-injection performed by the first fuel injection valve.
